(19) United States
(12) Patent Application Publication
(10) Pub. No.: US 2026/0079480 A1
(43) Pub. Date: Mar. 19, 2026

(54) DYNAMIC SURFACE PRODUCTION ASSETS

(71) Applicant: Schlumberger Technology Corporation, Sugar Land, TX (US)

(72) Inventors: Salma Benslimane, Menlo Park, CA (US); Indranil Roychoudhury, Menlo Park, CA (US); Priya Mishra, Houston, TX (US); Hui Wang, Menlo Park, CA (US); Jose R. Celaya Galvan, Menlo Park, CA (US); Pradeep Kumar Shetty, Houston, TX (US); Naveen Gupta, Menlo Park, CA (US)

(21) Appl. No.: 19/326,952

(22) Filed: Sep. 12, 2025

Related U.S. Application Data
(60) Provisional application No. 63/694,559, filed on Sep. 13, 2024.

(51) Int. Cl. G05B 23/02

(52) U.S. Cl. CPC G05B 23/0221; G05B 23/0243

(57) ABSTRACT

A method for building a production asset time-series foundation model includes receiving input data related to equipment. The input data includes (1) domain knowledge and equations related to the equipment and (2) metadata related to the equipment. The method also includes training the production asset time-series foundation model based upon the input data to produce a trained production asset time-series foundation model. The method also includes performing a downstream task using the trained production asset time-series foundation model. The downstream task includes forecasting, imputation, anomaly detection, history matching, health monitoring, or a combination thereof.

### CROSS-REFERENCE TO RELATED APPLICATIONS

This application claims priority to U.S. Provisional Patent Application No. 63/694,559, filed on Sep. 13, 2024, which is incorporated by reference.

### BACKGROUND

A time-series model is designed to handle data where observations are sequential and often dependent on time. The time-series model can inherently capture temporal dependencies and patterns. Conventionally, time-series models involve individual training for each task in a single domain. While the conventional approach of individual training is effective, it poses challenges, in particular, scalability issues.

Additionally, different assets (e.g., equipment) in a production facility encompass a wide array of time-series sensor readings that are useful for monitoring performance and ensuring efficient operation. As such, understanding this data and deriving knowledge from it for decision-making is helpful for production workflows.

Therefore, what is needed is an improved system and method for building a production asset time-series foundation model to evaluate dynamic surface production assets.

### SUMMARY

A method for building a production asset time-series foundation model is disclosed. The method includes receiving input data related to equipment. The input data includes (1) domain knowledge and equations related to the equipment and (2) metadata related to the equipment. The method also includes training the production asset time-series foundation model based upon the input data to produce a trained production asset time-series foundation model. The method also includes performing a downstream task using the trained production asset time-series foundation model. The downstream task includes forecasting, imputation, anomaly detection, history matching, health monitoring, or a combination thereof.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data related to equipment. The input data includes time-series data. The input data is multivariate and/or multimodal. The input data includes multiple time-dependent variables. The equipment is production equipment for oil and/or gas. The equipment includes a compressor, a pump, a heat exchanger, a motor, or a combination thereof. The input data includes measured data related to the equipment. The measured data includes pressure, temperature, rotational speed, oil level, oil quality, or a combination thereof. The measured data is time-stamped. The input data also includes domain knowledge and equations related to the equipment. The domain knowledge and equations describe initial boundary conditions, geometrical constraints, expected behavior, thermodynamic behavior, fluid dynamic behavior, mechanical behavior, or a combination thereof. The input data also includes metadata related to the equipment. The metadata describes a state of the equipment and processes performed by the equipment. The metadata includes text labels, categorical labels, external constraints, or a combination thereof. The external constraints includes static and dynamic variates. The operations also include training a production asset time-series foundation model based upon the input data to produce a trained production asset time-series foundation model. The operations include performing a downstream task using the trained production asset time-series foundation model. The downstream task includes forecasting, imputation, anomaly detection, history matching, health monitoring, or a combination thereof.

A non-transitory computer-readable medium is also disclosed. The medium includes instructions that, when executed by one or more processors of a computing system, cause the computing system to perform operations. The operations include receiving input data related to equipment. The input data includes time-series data. The input data is multivariate and/or multimodal. The input data includes multiple time-dependent variables. The equipment includes production equipment for oil and/or gas. The equipment includes a compressor, a pump, a heat exchanger, a motor, or a combination thereof. The input data includes measured data related to the equipment. The measured data includes pressure, temperature, rotational speed, oil level, oil quality, or a combination thereof. The measured data is time-stamped. The input data also includes simulated data that models the equipment in different configurations. The equipment uses or processes a fluid. The fluid includes hydrocarbons, lubricating fluid, natural gas, air, or a combination thereof. The simulated data is generated by varying: (1) a type of the fluid, a compressibility factor of the fluid, a representation of the fluid, composition thermodynamic parameters of the fluid, or a combination thereof; (2) an efficiency of the equipment including efficiency-related channels that model anomalies and/or faults; (3) characteristics of the equipment including geometry, capacity, age, maintenance count, manufacturer, or a combination thereof; and (4) configurations of a model that generates the simulated data. The configurations are modified by using different thermodynamic models determining output data based upon a simulated measurement from a sensor. The input data also includes domain knowledge and equations related to the equipment. The domain knowledge and equations describe initial boundary conditions, geometrical constraints, expected behavior, thermodynamic behavior, fluid dynamic behavior, mechanical behavior, or a combination thereof. The input data also includes metadata related to the equipment. The metadata describes a state of the equipment and processes performed by the equipment. The metadata includes text labels, categorical labels, external constraints, or a combination thereof. The external constraints include static and dynamic variates. The operations also include training a production asset time-series foundation model based upon the input data to produce a trained production asset time-series foundation model. The production asset time-series foundation model is pre-trained on a masked reconstruction task that applies masking strategies to the input data. The masked reconstruction task includes masking the input data based on a masking strategy and training the production asset time-series foundation model to predict a masked portion of the input data. The masking strategy includes random masking, masking based on the external constraints, and/or masking based upon the domain knowledge so that a learned latent representation of the input data by the production asset time-series foundation model is robust for a downstream task. The operations also include performing the downstream task using the trained production asset time-series foundation model.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 depicts an example computing system for performing at least a portion of the method(s) described herein, according to an embodiment.

FIG. 2 illustrates an overview diagram of a production asset time-series foundation model (TSFM), according to an embodiment.

FIG. 3 illustrates a schematic view showing that, upon generating synthetic data, the synthetic data can be stored into a container in a format that can allow for later model pretraining, according to an embodiment.

FIG. 4 illustrates an overview of a diagram for history matching, according to an embodiment.

FIG. 5 illustrates a flowchart of a method for building a production asset time-series foundation model, according to an embodiment.

FIGS. 6A and 6B illustrate graphs showing the MAE result of zero-shot evaluation of models for the short-term and long-term forecasting task, according to an embodiment.

FIGS. 7A and 7B illustrate graphs showing the MAE results of fine-tuning models with different training fractions on short-term forecasting task, according to an embodiment.

FIGS. 8A and 8B illustrate graphs comparing the MAE for short-term and long-term forecasting task for the four models, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Computing Systems

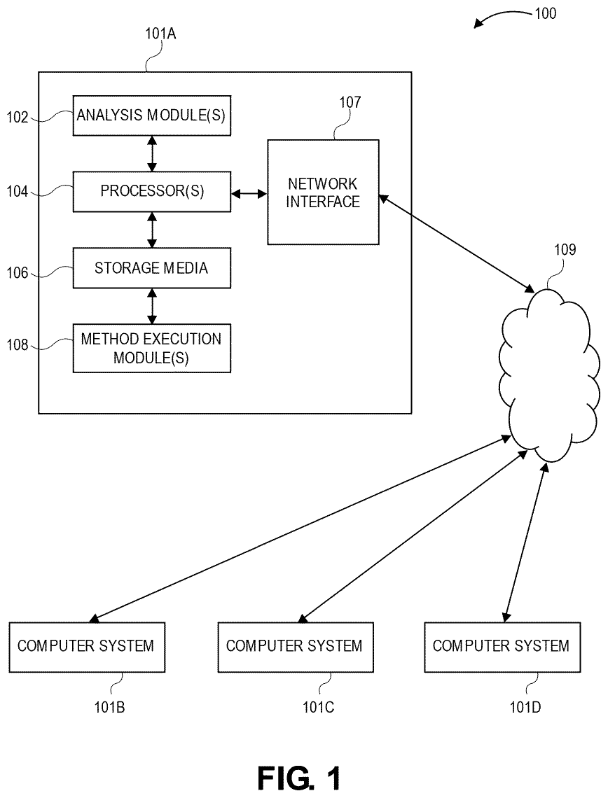

FIG. 1 depicts an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computer systems with keyboards, mice, touch screens, displays, etc. Some computer systems in use in computing system 100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

### Dynamic Surface Production Assets

Attention is now directed to methods, techniques, and workflows for processing and/or transforming collected data that are in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion. This concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

According to one embodiment, a time-series foundation model can be built and/or developed. In some cases, the time-series foundation model built can be a production asset time-series foundation model. The time-series foundation model has the following properties: (1) specific to surface dynamic production assets (e.g., equipment), (2) zero-shot/out of the box prediction, (3) continuous update with new data to adapt to changing conditions and maintaining accuracy over time, and (4) easy adaptation to multitask or multi-asset with relatively little additional data. Additionally, large time-series foundation models (TSFMs) are not trained on any one-time-series or domain. As such, TSFMs are more capable of performing zero-shot/few-shot predictions on new time-series inputs that were not seen in their training data while matching or even exceeding the state-of-the-art performance of full-shot models that were trained on the individual target datasets. These models, however, can be adapted for specific domains and use cases.

Production surface assets such as compressors, pumps, and heat exchangers generate heterogeneous data. This data includes, but is not limited to, time-stamped pressure measurements from pressure sensors, thermal data from temperature sensors, the rotational speed of the motor from speed sensors, pressure measurements from oil sensors, temperature measurements from oil sensors, level measurements from oil sensors, and quality of lubrication oil measurements from oil sensors, providing a temporal view of these parameters. There is also metadata such as operational mode and maintenance records of the assets.

Beyond the time-series properties, various physics equations describe the thermodynamic, fluid dynamic, and mechanical behavior. Conventional TSFMs claim that they can achieve excellent performance on time-series forecasting. However, in benchmarking, the conventional TSFMs struggle to generalize effectively to specific asset data. For example, the characteristics of domain data belonging to an entity can make state of the art TSFMs especially challenging to forecast.

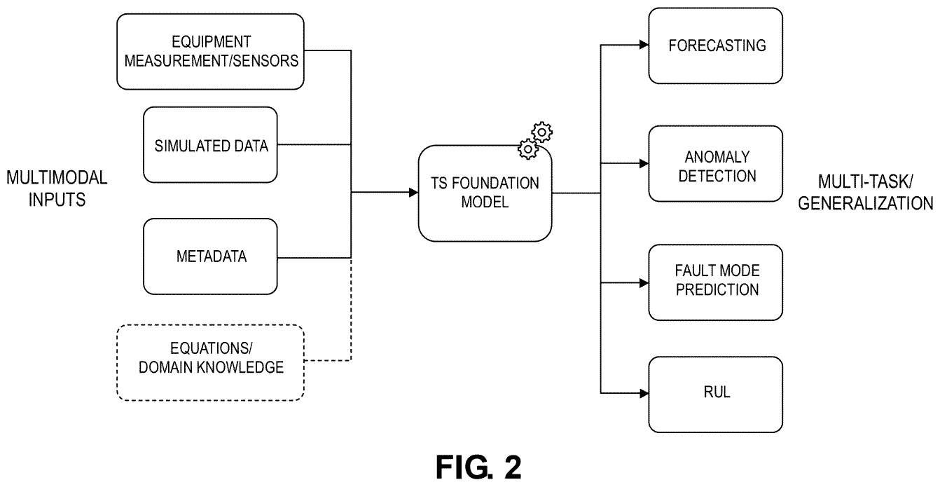

FIG. 2 illustrates an overview diagram of a production asset TSFM, according to an embodiment. To integrate time-series data, metadata, and physics equations from assets, an asset TSFM can be built that can handle multivariate data, and capture the interplay between multiple time-dependent variables. The asset TSFM can provide more comprehensive insights, especially for asset data where multiple factors influence the outcome.

In order to build the production asset TSFM, a process simulation software can be used to create and generate a synthetic dataset that models different equipment in different configurations. The flexibility provided by software simulators comes from the ability to generate long horizon datasets, model faults and anomalies, and control the characteristics. One example of a simulation software is Symmetry® (SLB, Houston, Texas).

In some cases, synthetic data can be generated by varying: (1) fluid types, (2) efficiency, (3) equipment characteristics, (4) symmetry configurations, and (5) facility location. In an example, varying fluid types can be represented by both categorical features (a) compressibility factor (e.g., compressible, incompressible), (b) fluid representation (e.g., oil, gas, etc.), and (c) numerical features (e.g., fluid composition thermodynamics parameters). In an example, efficiency can be varied based on efficiency related channels for specific equipment which models anomalies and faults. In an example, varying equipment characteristics can include geometry, capacity, equipment age, maintenance count, equipment manufacturers, etc. In an example, varying symmetry configurations can include for each equipment, different hydraulic models to calculate output data from a given synthetic sensor measurement. In an example, varying facility location can include different facilities that may use equipment in different ways.

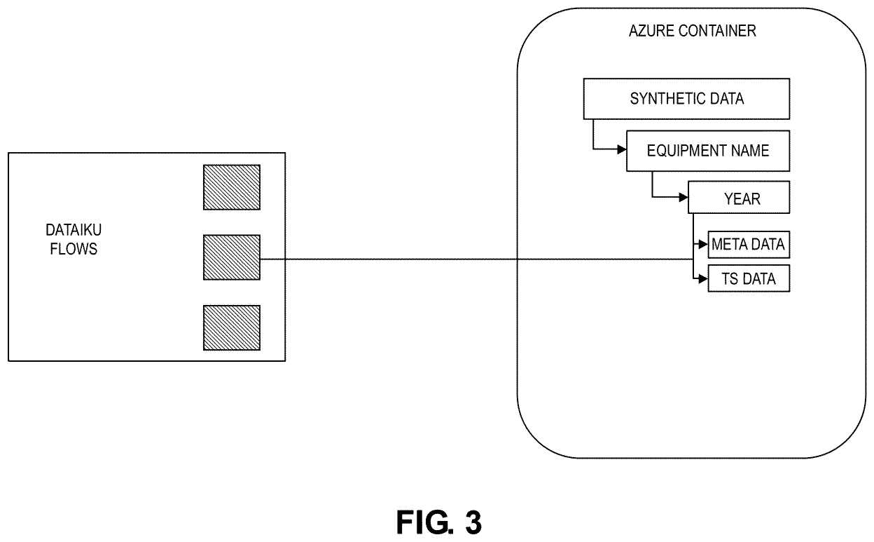

FIG. 3 illustrates a schematic view showing that, upon generating synthetic data, the synthetic data can be stored into a container in a format that can allow for later model pretraining, according to an embodiment.

According to one embodiment, a time-series foundation model can first optimize a pre-training objective goal. This is in contrast to conventional machine learning approaches where a model is trained to directly optimize an objective function related to a task or application. In order to train the time-series foundation model with a pre-training objective goal, a large amount of time-series data related to assets may be used. However, it can be difficult to overcome the challenge of using the large amount of time-series data due to issues like data ownership and availability. In order to do so, large scale synthetic data can be used. Additionally, another way to overcome the challenge includes combining the large scale synthetic data with available real data. As such, the time-series foundation model can be built using a large scalable pipeline that can generate synthetic data for production assets. By developing and/or generating synthetic pretraining data to train the time-series foundation model, the time-series foundation model can be built and/or implemented for domain specific cases for production assets.

Once pre-training is completed for the time-series foundation model, the time-series foundation model can be adapted for multiple downstream tasks. For example, the time-series foundation model can be adapted for forecasting, imputation, and anomaly detection with little to no modifications to the architecture. In some cases, the time-series foundation model can generate additional embeddings than other time-series foundation models that are trained on public datasets. As such, the time-series foundation models built and/or developed using synthetic pretraining data can include better zero-shot capabilities on a new unseen dataset. Additionally, the time-series foundation model can be fine-tuned (e.g., with a few examples or adopted by similar assets by employing transfer learning or retraining techniques).

In some cases, pretraining the time-series foundation model on a specific objective can result in the time-series foundation model that is able to learn the distribution and discern underlying patterns in a large dataset. Further, pretraining the time-series foundation model on a specific objective can allow for multiple new applications for modeling production assets including history matching and health monitoring. For example, high-dimensional embedding space may be learned via an objective function. In the high dimensional space, a data set with similar patterns may form a cluster, and therefore, the proximity in this latent space becomes an indicator of the similarity and dissimilarity between the corresponding inputs in the original space.

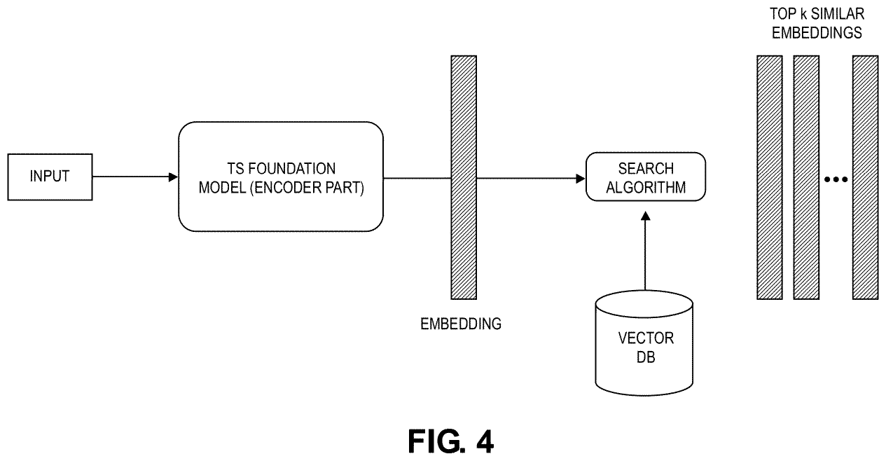

FIG. 4 illustrates an overview of a diagram for history matching, according to an embodiment. The application of history matching can also be exploited to search time-series patterns in the past and understand assets behavior for modeling and facilitating decision making regarding maintenance and repairs. Another application of modeling production assets includes health monitoring, or more specifically, prognostics and health management (PHM) is described in U.S. Provisional Application No. 63/694,416 filed on Sep. 13, 2024, which is hereby incorporated by reference in its entirety.

According to an embodiment, the time-series foundation model can analyze and understand the behavior of surface asset equipment and be able to perform analysis in a zero-shot manner without a retraining effort for each piece of equipment. By building and/or training the time-series foundation model on large synthetic data and real dataset (as opposed to public dataset) and integrating modalities, the time-series foundation model can perform zero shot and/or few shot predictions on asset data.

The steps in the processing methods described above may be implemented by running one or more functional modules in information processing apparatuses such as general purpose processors or application specific chips, such as ASICs, FPGAs, PLDs, or other appropriate devices. These modules, combinations of these modules, and/or their combination with general hardware are included within the scope of protection.

Many processing techniques for collected data, including one or more of the techniques and methods disclosed herein, may also be used successfully with collected data types other than seismic data. While certain implementations have been disclosed in the context of seismic data collection and processing, those with skill in the art will recognize that one or more of the methods, techniques, and computing systems disclosed herein can be applied in many fields and contexts where data involving structures arrayed in a multi-dimensional space and/or subsurface region of interest may be collected and processed (e.g., medical imaging techniques such as tomography, ultrasound, MRI and the like for human tissue; radar, sonar, and LIDAR imaging techniques; mining area surveying and monitoring, oceanographic surveying and monitoring, and other appropriate multi-dimensional imaging problems).

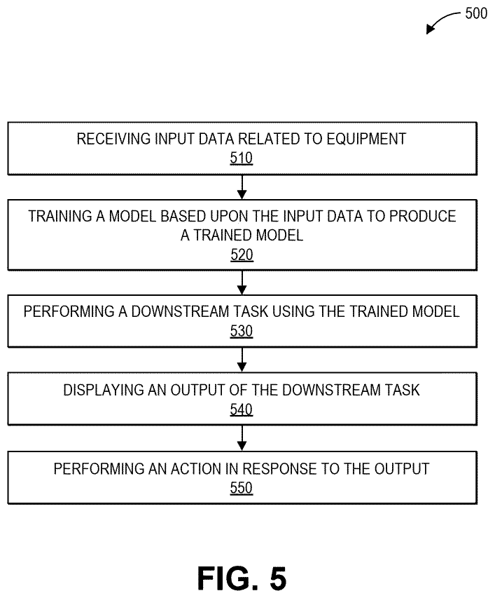

FIG. 5 illustrates a flowchart of a method 500 for building a production asset time-series foundation model, according to an embodiment. An illustrative order of the method 500 is provided below; however, one or more portions of the method 500 may be performed in a different order, simultaneously, repeated, or omitted. At least a portion of the method 500 may be performed using a computing system.

The method 500 may include receiving input data related to equipment, as at 510. The input data may be or include time-series data. The input data may be multivariate and/or multimodal. The input data may include multiple time-dependent variables.

The input data may include measured data related to the equipment. The measured data may include pressure, temperature, rotational speed, oil level, oil quality, or a combination thereof. The measured data may be time-stamped. The equipment may be or include production equipment for oil and/or gas operations. For example, the equipment may be or include a compressor, a pump, a heat exchanger, a motor, or a combination thereof.

The input data may also or instead include simulated data that models the equipment in different configurations. The equipment may use or process a fluid. The fluid may be or include hydrocarbons, lubricating fluid, natural gas, air, or a combination thereof. The simulated data may be generated by varying a type of the fluid, a compressibility factor of the fluid, a representation of the fluid, composition thermodynamic parameters of the fluid, or a combination thereof. The simulated data may also or instead be generated by varying an efficiency of the equipment including efficiency-related channels. The efficiency-related channels may model anomalies and/or faults. The simulated data may also or instead be generated by varying characteristics of the equipment including geometry, capacity, age, maintenance count, manufacturer, or a combination thereof. The simulated data may also or instead be generated by varying configurations of a model that generates the simulated data. The configurations may be modified by using different thermodynamic models determining output data based upon a simulated measurement from a sensor.

The input data may also or instead include domain knowledge and equations related to the equipment. The domain knowledge and equations may describe initial boundary conditions, geometrical constraints, thermodynamic behavior, fluid dynamic behavior, mechanical behavior, or a combination thereof. An example of domain knowledge may include the minimum and/or maximum limit of pressure or temperature readings or consideration of the type of assets to which particular thermodynamic equations are applicable. An example of the equations may include thermodynamic process equations relating pressure and temperature readings.

The input data may also or instead include metadata related to the equipment. The metadata describes a state of the equipment and processes performed by the equipment. The metadata may include text labels, categorical labels, external constraints, or a combination thereof. The external constraints comprise static and dynamic variables. Examples of the metadata may include information about the availability of extra sensor channels, indicating whether the equipment is in a specific operating mode or describing the current state of that mode, details about the last maintenance performed or the manufacturing ID of the equipment.

The method 500 may also include training the production asset time-series foundation model based upon the input data to produce a trained production asset time-series foundation model, as at 520. The production asset time-series foundation model may be pre-trained on a masked reconstruction task that applies masking strategies to the input data. The masked reconstruction task may include masking the input data based on a masking strategy and/or training the production asset time-series foundation model to predict a masked portion of the input data. The masking strategy may include random masking, masking based on the external constraints, and/or masking based upon the domain knowledge so that a learned latent representation of the input data by the production asset time-series foundation model is robust for a downstream task.

The method 500 may also include performing the downstream task using the trained production asset time-series foundation model, as at 530. The downstream task may be related to production and/or refinement of oil and/or gas. In one example, the downstream task may include forecasting, imputation, anomaly detection, history matching, health monitoring, or a combination thereof.

The method 500 may also include displaying an output of the downstream task, as at 540. For example, this may include displaying an output of the forecasting, imputation, anomaly detection, history matching, and/or health monitoring. An example of the history matching is shown in FIG. 4.

The method 500 may also include performing an action based upon and/or in response to the output of the downstream task, as at 550. In one embodiment, performing the action may include generating or transmitting a signal that recommends, instructs, or causes a physical action to occur (e.g., at a wellsite and/or an oil and gas processing facility). In another embodiment, performing the action may include performing a physical action. In an example, the physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Are Time Series Foundation Models Really Promising in Understanding Equipment Behaviors

Time series foundation model (TSFM) may be used to develop an out-of-the-box universal forecaster for time series data. These models may have superior performance on open-source public datasets compared to full-shot models, promising state-of-the-art results across various applications. Nonetheless, their performance in specialized domains, like oil and gas production equipment, remain unknown. The following paragraphs analyze six prominent TSFMs on four different compressor datasets to analyze their generalization performance in forecasting future values of equipment measurements like pressure and temperature. Additionally, several unanswered questions are explored related to their applicability in industrial settings like comparison of TSFMs against a baseline model, and fine-tuning a TSFM with different training fractions. The results suggest (1) some TSFMs are unable to show reasonable performance in the out-of-the-box mode for both short-term and long-term forecasting tasks for industrial equipment, (2) a smaller sequence-to-sequence (Seq2Seq) Long Short-Term Memory (LSTM) baseline may be comparable or possibly outperforms some of these TSFMs as well, and (3) fine-tuning a TSFM may not improve the model performance and the amount of data used for finetuning is critical for improved performance.

Time series data is ubiquitous across various domains and industries and holds relevance in many real-world dynamical systems, such as weather, economics, and energy. Techniques for analyzing time series data have been widely and extensively studied using statistical methods, machine learning, deep learning models, and more recently, foundation models. Large deep learning models have been dominant in the vision and language space, however, their effectiveness for multiple time series data is yet to be proven. Unlike vision and language modalities, which have consistent rules and grammar to dictate structures in data, time series data is comparatively more unstructured and complex. This heterogeneity may be attributed to one or multiple reasons, such as: (1) inconsistent temporal resolutions and sampling frequencies, (2) correlation with other variables, and varying number of channels, (3) mismatch due to different lengths of measurements from various sensors, and (4) amplitude differences among time series channels due to the nature of measurements. Despite these challenges in modeling time series data, deep learning models have shown success and have sometimes even surpassed traditional time series methods, thanks to the neural network's universal function approximation capability.

Recent advancements in the language and vision domains have revealed that large language models (LLMs) and vision language models (VLMs) have robust pattern recognition capabilities. This development has sparked growing interest in foundation models (FMs) for the time series community and motivated several research questions such as: (1) can we design one large model that can learn diverse trend and seasonality characteristics in time series data? (2) can these large Time Series Foundation Models (TSFM) be used out-of-the-box on the new unseen data? (3) while the classical machine learning models advocate for task-specific models, can the TSFM be task agnostic? (4) can a TSFM model be a universal forecaster that can handle varying context lengths and predict varying future horizons? Early signs of designing a universal model for time series analysis exist. A common theme across these models is that they are first pre-trained on a large cohesive custom-curated dataset from the public domain on the masked reconstruction problem. In the second stage, the model is either directly used or fine-tuned for different time series tasks with or without supervision.

In a production facility, mechanical equipment is used to capture physical phenomena, hence, they are linked to various factors such as inputs and outputs, physical processes, mathematical equations, and operating environment. They demonstrate processes to maintain certain pressure or temperature conditions for multiple applications such as transportation, liquefaction, and many more. The physics of the equipment exhibits temporal dependencies in the measurements and thus it opens a new research avenue to investigate the application of TSFMs for prognostics and health monitoring (PHM) applications. The energy industry employs tailored models for equipment maintenance and decision-making, leading to inefficiencies in time and cost. A TSFM model can be useful in condition-based maintenance (CBM) by performing maintenance activities at certain times. CBM integrates automated monitoring, detection, and predictive capabilities to anticipate equipment degradation.

Despite the variety of architecture proposed to develop general-purpose TSFMs, there are still open questions that remain unanswered related to their application to industrial equipment like: (1) do these TSFMs outperform or show competitive performance compared to conventional machine learning methods? and (2) can fine-tuning a TSFM help improve model performance? Described herein is a schematic approach to study the generalization performance of recently published open-source TSFMs to probe their understanding of production equipment and address these two questions. The exemplary method described herein focuses on analyzing compressor equipment utilized in the production pipeline of oil and gas downstream operations. Sensor data is captured from four compressors over various time periods, and the method evaluates six cutting-edge TSFM in a zero-shot setting. The two top-performing models were fine-tuned to explore their potential for industrial applications.

The applicability of large TSFMs for industrial equipment involves a comprehensive approach that takes into account a multitude of factors. These include the inputs and outputs associated with an equipment, the mathematical equations governing the physical phenomena, auxiliary physical processes, and operating condition of an equipment in a facility. Large TSFMs have demonstrated potential in becoming a universal forecaster for a wide range of domains, such as stock market and traffic predictions, largely due to their ability to leverage vast datasets. However, these models may not fully encompass the factors for an accurate modeling of production equipment. For example, the architecture of TSFMs may not distinguish between input and output space associated with an equipment, nor to the mathematical equations that are relevant to understanding the underlying physical processes.

Despite the limitations of TSFMs in capturing these intricacies, there may be some attributes inherent to these models that can be advantageous as well. First, the equipment data from production facility may be unstructured (i.e., sensor data may be noisy and have different lengths for different channels). Depending on the architecture, a TSFM can account for varying context length and predict multiple forecasting horizons to enable CBM monitoring. Second, the equipment may generate multivariate measurements where the recorded variates often show a strong correlation among themselves or with a target variate. Many of these TSFMs consider exogenous variables for an accurate prediction of target variables. Last but not least, the solution should also have a low inference cost so that it can be deployed on cheaper hardware in a production facility. If a TSFM has high inference cost, it can leverage several techniques, like quantization, to reduce inference cost.

The examples herein focus on compressors, primarily due to availability of relevant datasets; however, the method described herein may also or instead apply to other types of equipment. Compressors are widely used in a production facility in many parts of the oil and gas process, from upstream production to gas plants, pipelines and petrochemical plants. There are different types of compressors such as reciprocating compressors, rotary screw compressors and centrifugal compressors, each with different characteristics such as operating power, speed, pressure, and volume. A compressor may be operated in a facility in conjunction with other physical equipment where the output from one equipment serves as input to another. While the physics of this system may be governed by thermodynamic principles and complex partial differential equations (PDEs), the applicability of a TSFM may enable an alternate solution that may be useful in modeling these systems. TSFMs may be used to evaluate how effective these models are in understanding production equipment, despite the challenges posed by the intricate dynamics of production equipment systems.

Consider a dataset of T timepoints for a compressor:

$$D = {( {X}^{( i )} , {Y}^{( i )} )}_{i = 1}^{T} , where {X}^{( i )} = ( {X}_{1}^{( i )} , {X}_{2}^{( i )} , … , {X}_{T}^{( i )} ) ∈$$

R^{(M×T)} are input with M channels and T timepoints and

$${Y}^{( i )} = ( {Y}_{1}^{( i )} , {Y}_{2}^{( i )} , … , {Y}_{T}^{( i )} ) ∈ {ℝ}^{( N \times T )}$$

are output N channels and T timepoints. Because a TSFM model does not distinguish the input and output space, the method may concatenate the X⁽ⁱ⁾ and Y(i) channels such that Z(i)=[X(i); Y(i)]^{∈}R((M+N)×T).

Given a TSFM model f, context length c, and stride s, one goal may be to forecast a channel Z⁽ⁱ⁾ in zero-shot mode for k timepoints. The set of target channels Z⁽ⁱ⁾ may or may not be a subset the set containing the channels Z⁽ⁱ⁾∈R^{((M+N)×T)}. If the TSFM model f considers one channel at a time, then the model prediction is given by

$$f ( {Z}_{t + c + 1 : t + c + k}^{( i )} ) = f ( {Z}_{t : t + c}^{( i )} ) .$$

The method may use

$$f ( {Z}_{t + c + 1 : t + c + k}^{( i )} ) = f ( {Z}_{t : t + c}^{( i )} ; {Z}_{t : t + c + k}^{( j )} ) ∀ j ∈ ( 1 , 2 , … , M + N ) \backslash i$$

for multivariate models, where

$${Z}_{t + c + 1 : t + c + k}^{( i )}$$

is the model prediction for Z⁽ⁱ⁾ channel from t+c+1 to t+c+k timepoints,

$${Z}_{t : t + c}^{( i )}$$

is the c length historical context for Z⁽ⁱ⁾ channel, and

$${Z}_{t : t + c + k}^{( j )}$$

is the c+k length containing both historical context and future values for other channels.

For fine-tuning, the method may use a certain fraction of a dataset D to re-align model weights of TSFM f using an objective function. After fine-tuning, the method may obtain the model f that could be evaluated using either of the formulations above depending upon whether it is univariate or multivariate.

This example includes four compressor datasets, out of which three, Comp-(A, B, C), are private and have a consistent number of channels, while the other compressor, Valhall Comp, is open-source data. These measurements are mostly related to input and output pressure and temperature readings at different stages of a production pipeline. While Comp-(A, B, C) are preprocessed by domain experts and are relatively cleaner, the Valhall Comp dataset is noisy and has missing values. The datasets may be sampled at different frequencies to reflect the real-world scenario where different compressors may have different sampling rates. The compressor dataset also has sensor readings to indicate engine ON and OFF state. The engine OFF state means that the equipment is at rest and other physical measurements are merely noise at those timepoints.

This example considers six time series foundation models based on different architectures, model sizes, univariate vs multivariate approaches, multi-input-output capabilities, and their availability. These foundation models are primarily trained on custom curated open-source time series datasets and have shown zero-shot capability with minimal supervision on different tasks on public datasets. In addition to FMs, the method also evaluates a baseline model Seq2Seq, based on LSTM architecture, to delineate the tradeoff between performance and computation when compared against large TSFM models. The baseline model is trained on the equipment dataset and is relatively smaller in size when compared to TSFMs.

To make a comprehensive evaluation, the method may use a schematic approach to investigate these models using a uniform setup to address several open-ended questions mentioned above. For example, the UniTS model can handle the input data with varying context lengths; however, TTM can accommodate the input data up to 512 context length. Therefore, for each experiment, the method may consider the context length of 512, the prediction length of 32 (e.g., short-term) and 96 (e.g., long-term), with the stride equal to the total of context and prediction length. Some of these models also consider cross-channel correlations, such as TTM and MOIRAI, while others consider a single input channel at a time, such as MOMENT and Lag-Llama. Depending upon the model's input-output ability, the method may evaluate six TSFMs under a zero-shot setting for both short-term and long-term forecasting.

The method may also investigate fine-tuning these models to explore the feasibility of improving their performance by training them using a certain fraction of an equipment dataset. For example, the method may consider three training fractions: 20%, 60%, and 80%, to assess how much data to align a general-purpose TSFM to the physical asset or equipment data. The fine-tuning process involves re-aligning the model weights by backpropagating the gradients using an objective function. For fine-tuning, the method may consider two multivariate models, MOIRAI and TTM.

To assess a model performance, the method may evaluate both qualitative and quantitative metrics. For quantitative evaluation, the method may compute metrics Mean Absolute Error (MAE) and Mean Square Error (MSE) across the channels. The method may compute the MAE and MSE metrics in a normalized space and therefore rescale the observed data and model prediction using a Standard Scaler. One reason behind employing normalized MAE and MSE is that compressors and other production equipment record multiple channels, and each potentially could reflect measurements on a different scale. The original MAE and MSE values may be disproportionately influenced by a channel with larger numerical values. As a result, it may be helpful to consider normalized evaluation metrics so that these metrics can reflect average performance of a model across the channels.

For qualitative evaluation, the method may visualize the predicted and observed data for both short-term and long-term forecasting across the channels. The analysis shows that the visual interpretation is more relevant in understanding whether a model's prediction accounts for historical temporal characteristics or not. While the quantitative metrics provide a point estimate of overall model performance and are useful in comparing models at an aggregate level, the qualitative evaluation aids in enhanced understanding of predictions at different timepoints. The experiments have consistently demonstrated reproducibility in metrics and results across multiple runs.

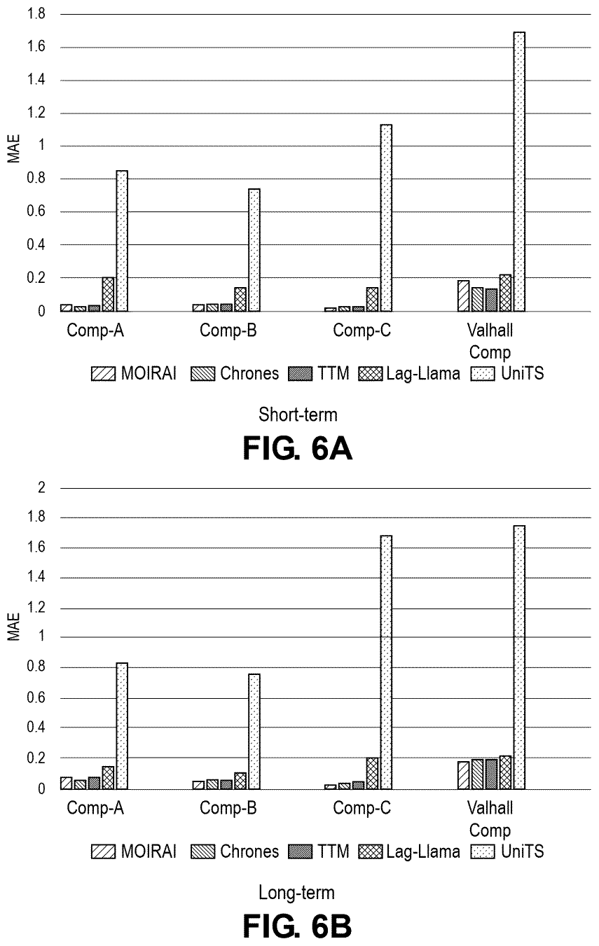

In this section, we present the results of several experiments to evaluate different time series models. As discussed above, the method may evaluate five foundation models on the compressor datasets with fixed context length, stride, and forecast horizon. The method may perform both short-term and long-term forecasting and compare their performances using MAE and MSE metrics. FIGS. 6A and 6B illustrate graphs showing the MAE result of zero-shot evaluation of models for the short-term and long-term forecasting task, according to an embodiment. The method used publicly available open-source checkpoints for the models in the inference mode. The method also provides quantitative evaluation of both MAE and MSE.

FIG. 6A shows that while MOIRAI is the best performing model for the Comp-B and Comp-C dataset, TTM shows the best result for Comp-A and Valhall-Comp dataset. The difference in MAE values for Comp-(A, B, C) datasets for MOIRAI, TTM, and Chronos is not large; however, the other foundation models fall short in comparison. For the Valhall-Comp dataset, it may be seen that the two best performing models-TTM and Chronos show similar performance, while the other remaining models have a larger MAE comparatively.

Similarly, the method may conduct the zero-shot evaluation for the long-term forecasting as highlighted in FIG. 6B. For the long-term forecasting, MOIRAI shows the best performance for the Comp-B, Comp-C, and Valhall-Comp datasets, while Chronos shows the best result for the Comp-A dataset. Like short-term forecast, a similar trend may be seen-MOIRAI, TTM, and Chronos show comparable performance with a very little difference. On the contrary, for Valhall-Comp dataset, the three models show similar performance.

The foundation models may be fine-tuned for the compressor dataset. One motivation behind fine-tuning is to explore the question: Can fine-tuning a TSFM help improving the model performance?

To address this question, the method may create three different training fractions (e.g., 0.2, 0.6, 0.8) and fine-tune the MOIRAI and TTM models at those fractions. These two models are selected as they are multivariate and show overall best performance across the datasets.

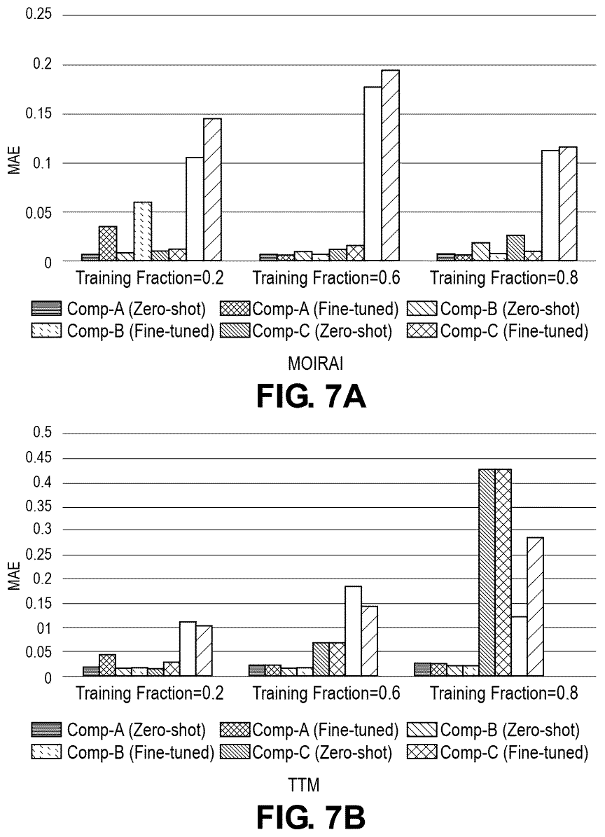

FIGS. 7A and 7B illustrate graphs showing the MAE results of fine-tuning MOIRAI and TTM models with different training fractions on short-term forecasting task, according to an embodiment. To understand the benefit of fine-tuning a model, the method also evaluates MOIRAI and TTM checkpoints (e.g., just trained on open-source public datasets) on the same test dataset that the fine-tuned MOIRAI and TTM checkpoints are evaluated. For example, a training fraction of 80% means fine-tuning a model, say MOIRAI, with 80% of a given compressor dataset, and MOIRAI (e.g., open-source checkpoint and fine-tuned) is then tested on the remaining 20% dataset.

FIG. 7A shows the result for MOIRAI-the fine-tuned model can outperform the open-source checkpoint only at 80% training fraction. The performance gap between the fine-tuned and open-source models reduces when training fraction is decreased to 60%. The performance of fine-tuned models is still comparable to the open-source checkpoint for most of the datasets. However, when the training fraction is further reduced to 20%, it may be observed that the open-source MOIRAI model starts to outperform the fine-tuned model. This trend suggests that the fine-tuning of the MOIRAI model may depend on the size of a training dataset to improve the performance of the open-source model (e.g., trained only on public datasets).

FIG. 7B shows the result for the TTM model. It may be seen that the fine-tuned models (at training fraction 60% and 80%) are performing comparable to the open-source checkpoint for Comp-(A, B, C) datasets. At training fraction 20%, the open-source model outperforms its fine-tuned counterpart for Comp (A, B, C) datasets, similar to the trend of MOIRAI fine-tuning at that training fraction. However, for the Valhall-Comp dataset, the comparison of the fine-tuned model with the open-source checkpoint reveals no clear trend.

The fine-tuning of the MOIRAI and TTM models may be examined to understand their behavior when adjusted with varying training fractions. At a 20% training fraction, the fine-tuned checkpoints perform worse compared to the publicly trained ones. This indicates that the fine-tuning may not be beneficial, particularly at the lower training fraction, and can further degrade a model performance. This degradation is likely due to noisy gradients during backpropagation when number of training examples are decreased. Therefore, fine-tuning a TSFM model may be used when there is a well representative training dataset with enough training examples and sufficient computational resources to support fine-tuning.

A Seq2Seq model (described above) may be compared with three TSFMs: MOIRAI, TTM, and MOMENT. Through this analysis, the second question raised above may be investigated: Do these TSFMs outperform or show similar performance compared to their conventional ML methods?

The Seq2Seq model may be trained based on LSTM architecture, with a training fraction of 0.6 (train/test=0.6/0.4), which has a good balance of training to testing data. To make a fair comparison, the TSFMs with open-source checkpoint (e.g., Zero-shot) and their fine-tuned version at training fraction of 0.6 may be compared, except MOMENT. The MOMENT model is an encoder-only architecture and thus its open-source checkpoint cannot be directly used in the zero-shot mode. The reconstruction head of the model may be trained at 0.6 training fraction for an epoch.

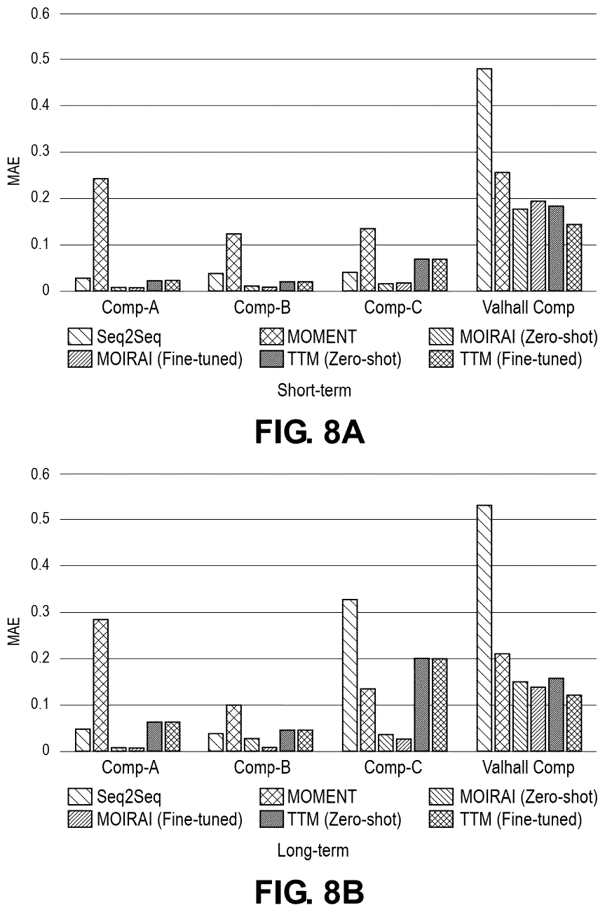

FIGS. 8A and 8B illustrate graphs comparing the MAE for short-term and long-term forecasting task for the four models-Seq2Seq, MOMENT, MOIRAI, and TTM, according to an embodiment. MOIRAI is the best performing model with very little differences in MAE between opensource checkpoint and fine-tuned version. While MOMENT shows the worst performance on Comp-(A, B, C) dataset, the baseline model becomes less preferrable for the Valhall Comp dataset on both short-term and long-term forecasting. The poor performance of Seq2Seq on Valhall Comp dataset may be attributed to the fact that the dataset is noisy and may involve data cleaning for accurate modeling. FIGS. 8A and 8B also highlight that the MOMENT model has a large margin in MAE difference when compared with other FMs and even Seq2Seq smaller model (˜2.6M parameters).

On the other hand, the performance of the baseline model on Comp-(A, B, C) datasets are comparable to MOIRAI and TTM, both open source checkpoint and fine-tuned version. This analysis highlights that a TSFM model may not show the best performance, especially with a large margin, and depending upon amount of data available, it may be better to train a smaller ML model with computationally cheaper alternative. However, the baseline model may be trained on an individual dataset may become stale over time and may also need to be re-trained with latest data from time-to-time.

The foregoing describes the performance of large TSFMs, compares them with the Seq2Seq baseline model, and fine-tunes two TSFMs under different training fractions. The current TSFMs may be based on three different types of architectures transformers, LLMs, and MLP-Mixer. The TSFMs based on LLMs are currently univariate and they primarily either adapt LLMs for time series or discretize time series data to treat them as language tokens. The present disclosure suggests a multi-variate TSFM model that is based on either transformers or MLP-mixer pretrained from scratch may be a good solution. The performance of these TSFMs is likely to improve when they are only fine-tuned with a sufficient number of training examples. A simple Seq2Seq baseline model can also outperform TSFMs while being computationally less intense; however, it may come with its own challenges such as: (1) designing a new architecture for each dataset; (2) training the model from scratch; (3) hyperparameter tuning; and (4) distribution shift. Additionally, compared to the baseline model, the TSFMs may exhibit greater resilience to noisy training data.

Examples of equations and mathematical expressions have been provided in this disclosure. But those with skill in the art will appreciate that variations of these expressions and equations, alternative forms of these expressions and equations, and related expressions and equations that can be derived from the example equations and expressions provided herein may also be successfully used to perform the methods, techniques, and workflows related to the embodiments disclosed herein.

While any discussion of or citation to related art in this disclosure may or may not include some prior art references, applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

Those with skill in the art will appreciate that while the quoted sections of the article above that are provided for illustrative purposes include terms that could be interpreted as potentially absolute or requiring a given thing (including without limitation “exactly”, “exact”, “only”, “key”, “important”, “requires”, “all”, “each”, “must”, “always”, etc.), the various systems, methods, processing procedures, techniques, and workflows disclosed herein are not to be understood as limited by the use of these terms

In some embodiments, the multi-dimensional region of interest is selected from the group consisting of a subterranean region, human tissue, plant tissue, animal tissue, solid volumes, substantially solid volumes, volumes of liquid, volumes of gas, volumes of plasma, and volumes of space near and/or outside the atmosphere of a planet, asteroid, comet, moon, or other body.

In some embodiments, the multi-dimensional region of interest includes one or more volume types selected from the group consisting of a subterranean region, human tissue, plant tissue, animal tissue, solid volumes, substantially solid volumes, volumes of liquid, volumes of air, volumes of plasma, and volumes of space near and/or or outside the atmosphere of a planet. asteroid, comet, moon, or other body.

What is claimed is:

1. A method for building a production asset time-series foundation model, the method comprising:
receiving input data related to equipment, wherein the input data comprises:
domain knowledge and equations related to the equipment; and
metadata related to the equipment;
training the production asset time-series foundation model based upon the input data to produce a trained production asset time-series foundation model; and
performing a downstream task using the trained production asset time-series foundation model, wherein the downstream task comprises forecasting, imputation, anomaly detection, history matching, health monitoring, or a combination thereof.

2. The method of claim 1, wherein the input data comprises time-series data, wherein the input data is multivariate and/or multimodal, wherein the input data comprises multiple time-dependent variables, wherein the input data further comprises measured data related to the equipment, wherein the measured data comprises pressure, temperature, rotational speed, oil level, oil quality, or a combination thereof, and wherein the measured data is time-stamped.

3. The method of claim 2, wherein the equipment comprises production equipment for oil and/or gas, and wherein the equipment comprises a compressor, a pump, a heat exchanger, a motor, or a combination thereof.

4. The method of claim 1, wherein the domain knowledge and equations describe initial boundary conditions, geometrical constraints, expected behavior, thermodynamic behavior, fluid dynamic behavior, mechanical behavior, or a combination thereof.

5. The method of claim 1, wherein the metadata describes a state of the equipment and processes performed by the equipment, wherein the metadata comprises text labels, categorical labels, external constraints, or a combination thereof, and wherein the external constraints comprise static and dynamic variates.

6. The method of claim 1, wherein the production asset time-series foundation model is pre-trained on a masked reconstruction task that applies masking strategies to the input data.

7. The method of claim 6, wherein the masked reconstruction task comprises masking the input data based on a masking strategy and training the production asset time-series foundation model to predict a masked portion of the input data.

8. The method of claim 7, wherein the masking strategy comprises random masking, masking based on external constraints, and/or masking based upon the domain knowledge so that a learned latent representation of the input data by the production asset time-series foundation model is robust for the downstream task.

9. The method of claim 1, further comprising displaying an output of the downstream task.

10. The method of claim 9, further comprising performing a physical action based upon and/or in response to the output of the downstream task.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data related to equipment, wherein the input data comprises time-series data, wherein the input data is multivariate and/or multimodal, wherein the input data comprises multiple time-dependent variables, wherein the equipment comprises production equipment for oil and/or gas, wherein the equipment comprises a compressor, a pump, a heat exchanger, a motor, or a combination thereof, and wherein the input data comprises:
measured data related to the equipment, wherein the measured data comprises pressure, temperature, rotational speed, oil level, oil quality, or a combination thereof;
domain knowledge and equations related to the equipment, wherein the domain knowledge and equations describe initial boundary conditions, geometrical constraints, expected behavior, thermodynamic behavior, fluid dynamic behavior, mechanical behavior, or a combination thereof; and
metadata related to the equipment, wherein the metadata describes a state of the equipment and processes performed by the equipment, wherein the metadata comprises text labels, categorical labels, external constraints, or a combination thereof, and wherein the external constraints comprise static and dynamic variates;
training a production asset time-series foundation model based upon the input data to produce a trained production asset time-series foundation model; and
performing a downstream task using the trained production asset time-series foundation model, wherein the downstream task comprises forecasting, imputation, anomaly detection, history matching, health monitoring, or a combination thereof.

12. The computing system of claim 11, wherein the input data further comprises simulated data that models the equipment in different configurations, wherein the equipment uses or processes a fluid, wherein the fluid comprises hydrocarbons, lubricating fluid, natural gas, air, or a combination thereof, and wherein the simulated data is generated by varying a type of the fluid, a compressibility factor of the fluid, a representation of the fluid, composition thermodynamic parameters of the fluid, or a combination thereof.

13. The computing system of claim 11, wherein the input data further comprises simulated data that models the equipment in different configurations, wherein the simulated data is generated by varying an efficiency of the equipment including efficiency-related channels, and wherein the efficiency-related channels model anomalies and/or faults.

14. The computing system of claim 11, wherein the input data further comprises simulated data that models the equipment in different configurations, and wherein the simulated data is generated by varying characteristics of the equipment including geometry, capacity, age, maintenance count, manufacturer, or a combination thereof.

15. The computing system of claim 11, wherein the input data further comprises simulated data that models the equipment in different configurations, wherein the simulated data is generated by varying configurations of a model that generates the simulated data, and wherein the configurations are modified by using different thermodynamic models determining output data based upon a simulated measurement from a sensor.

16. A non-transitory computer-readable medium storing instructions that, when executed by one or more processors of a computing system, cause the computing system to perform operations, the operations comprising:
receiving input data related to equipment, wherein the input data comprises time-series data, wherein the input data is multivariate and/or multimodal, wherein the input data comprises multiple time-dependent variables, wherein the equipment comprises production equipment for oil and/or gas, wherein the equipment comprises a compressor, a pump, a heat exchanger, a motor, or a combination thereof, and wherein the input data comprises:
measured data related to the equipment, wherein the measured data comprises pressure, temperature, rotational speed, oil level, oil quality, or a combination thereof, wherein the measured data is time-stamped;
simulated data that models the equipment in different configurations, wherein the equipment uses or processes a fluid, wherein the fluid comprises hydrocarbons, lubricating fluid, natural gas, air, or a combination thereof, and wherein the simulated data is generated by varying:
a type of the fluid, a compressibility factor of the fluid, a representation of the fluid, composition thermodynamic parameters of the fluid, or a combination thereof;
an efficiency of the equipment including efficiency-related channels, wherein the efficiency-related channels model anomalies and/or faults;
characteristics of the equipment including geometry, capacity, age, maintenance count, manufacturer, or a combination thereof; and
configurations of a model that generates the simulated data, wherein the configurations are modified by using different thermodynamic models determining output data based upon a simulated measurement from a sensor;
domain knowledge and equations related to the equipment, wherein the domain knowledge and equations describe initial boundary conditions, geometrical constraints, expected behavior, thermodynamic behavior, fluid dynamic behavior, mechanical behavior, or a combination thereof; and
metadata related to the equipment, wherein the metadata describes a state of the equipment and processes performed by the equipment, wherein the metadata comprises text labels, categorical labels, external constraints, or a combination thereof, and wherein the external constraints comprise static and dynamic variates; and
training a production asset time-series foundation model based upon the input data to produce a trained production asset time-series foundation model, wherein the production asset time-series foundation model is pre-trained on a masked reconstruction task that applies masking strategies to the input data, wherein the masked reconstruction task comprises masking the input data based on a masking strategy and training the production asset time-series foundation model to predict a masked portion of the input data, and wherein the masking strategy comprises random masking, masking based on the external constraints, and/or masking based upon the domain knowledge so that a learned latent representation of the input data by the production asset time-series foundation model is robust for a downstream task; and
performing the downstream task using the trained production asset time-series foundation model.

17. The non-transitory computer-readable medium of claim 16, wherein the downstream task comprises forecasting, imputation, anomaly detection, history matching, health monitoring, or a combination thereof.

18. The non-transitory computer-readable medium of claim 17, wherein the operations further comprise performing an action based upon and/or in response to an output of the downstream task.

19. The non-transitory computer-readable medium of claim 18, wherein the action comprises generating or transmitting a signal that recommends, instructs, or causes a physical action to occur.

20. The non-transitory computer-readable medium of claim 19, wherein the physical action comprises drilling a wellbore, varying a weight and/or torque on a drill bit that is drilling the wellbore, varying a drilling trajectory of the wellbore, varying a concentration and/or flow rate of a fluid pumped into the wellbore, or a combination thereof.
